(19) United States
(12) Patent Application Publication
(10) Pub. No.: US 2012/0061339 A1
(43) Pub. Date: Mar. 15, 2012

(54) CONCATENATE SAFETY TOOL SUSPENSION STRUCTURE

(76) Inventor: CHI-TSAI CHANG, Taichung City (TW)

(21) Appl. No.: 13/050,921

(22) Filed: Mar. 17, 2011

(30) Foreign Application Priority Data
Sep. 13, 2010 (TW) 099217718

(51) Int. Cl. B25H 3/04; A47F 7/00; B65D 85/20

(52) U.S. Cl. 211/70.6

(57) ABSTRACT

A concatenate safety tool suspension structure includes multiple individual suspension couplers that each carries a socket like tool piece. The couplers are concatenated to each other to form an elongate suspension structure. Each coupler has a side face to which a retention member is mounted and extending therefrom to receive a tool piece to fit thereto. Each coupler has an upper end forming an insertion section that is of a peg like stepwise configuration. Each coupler forms therein a corresponding insertion slot and a through hole in an upper end of the insertion slot to receive the insertion of an insertion section of another coupler to realize concatenated connection. The insertion section has an upper end forming a barb that engages the through hole to secure two couplers together. A suspension board is provided above and connected to the insertion section of the uppermost one of the couplers.

### (A) TECHNICAL FIELD OF THE INVENTION

The present invention generally relates to a concatenate safety tool suspension structure, which comprises a coupler, to which a socket like tool piece can be fit, forming an insertion section to be directly insertable into a hollow insertion slot formed inside another coupler to connect the couplers together in a concatenate form, wherein the insertion section has a barbed connection formed at one end thereof to allow for easy interconnection between couplers and arrangement of tool pieces in a cascade form, and a pin is provided for selective insertion into a retention member of the coupler that receives the tool piece to fit thereto so as to secure the tool piece against theft, whereby the tool pieces that are arranged in cascade can be suspended in a properly positioned and theft resistant manner.

### (B) DESCRIPTION OF THE PRIOR ART

Socket-like tool pieces are often packed and stored in such a way that multiple tool pieces of different sizes are put together for ready and convenient access and use. The storage is often made with a tool box, in which the socket-like tool pieces are held by in an inserted and spaced fashion. However, using a tool box for storage requires a high cost for packaging, and often occupies additional space and is troublesome for use and storage. Further; such a package is often wrapped or covered by a protection film for theft protection and thus, it is difficult for a consumer, in attempting to purchase the tool pieces, to properly inspect the tool pieces. Further, such tool pieces that are packed in multiplicity as a set only allow a consumer to purchase by set, but such a wrapped package prevents the consumer from touching and closely inspecting the tool pieces. The arrangement of a single package containing multiple tool pieces is also troublesome to and may hinder a consumer, who may just need one or a few of the tool pieces, from purchasing the whole package. Further, although the tool box based package of multiple tool pieces provides convenience for future storage, yet such a package makes it trouble in that all the tool pieces that are contained in the tool box must be carried together. Thus, in order to properly store and keep the socket-like tool piece, a vertically cascade arrangement of storage suspension devices is known, as shown in FIGS. 6 and 7, wherein a rail bar 31 is vertically arranged and has a top end that forms a suspension board 32 for suspending. The rail bar forms a T-shaped rail that extends a predetermined length to receive couplers 33 each of which has an inner end forming a T-shaped slot 34 for fitting purpose to slidably fit to the rail bar 31 and thus lining up along the bar. Each coupler 33 has an opposite outer end forming a retention projection to which a socket-like tool piece may be fit. After multiple couplers are fit to and line up along the rail bar, a fixer end piece is then fit to the bottom of the bar to retain the couplers in position, preventing the couplers 33 from falling when they are put in suspension. This known structure only functions for storage and suspension, but is not capable of preventing the socket-like tool pieces from detaching from the couplers or being stolen. And, it is also in the form of package for a whole set of tool pieces, and again, the consumers are not provided with options for some of the tool pieces. In addition, such a package, when suspended, still requires additional security measures against theft. In the point of view of consumers, they still need to purchase additional and perhaps undesired tool pieces in purchasing such a whole package, and again, the outside cover of the package prevents the consumers from directly inspecting the tool pieces. Apparently, the consumers' general needs are not satisfied. The packaging cost is high and cannot be reduced. Besides high manufacturing cost, the fitting type arrangement of the rail bar having a fixed length generally may not be fit to the practical process of manufacturing and does not meet the needs of general consumers. Although such a suspension package structure of socket-like tool pieces provides advantages in access and storage of the tool pieces, it is still a challenge to improve the existing suspension structure of socket-like tool pieces so as to make it meet practical needs, to allow consumers to easily inspect and to protect against theft in a condition of being exhibited for sale.

### SUMMARY OF THE INVENTION

In view of the problem of the existing socket like tool piece suspension structure that does not completely meet the needs for packaging, suspension, and exhibition for sale of the socket like tool pieces, the present invention aims to provide a concatenate safety tool suspension structure, which comprises multiple individual couplers, each of which comprises an insertion section extending from an upper end thereof and has a side face to which a resiliently deflectable retention member having one unfixed side wall that defines an open gap is fixed. Complementary with and corresponding to a stepwise peg like configuration of the insertion section on the upper end of the coupler, the coupler forms therein a hollow stepwise insertion slot that receives the insertion section of another coupler to fit therein so as to realize a concatenate suspension structure through concatenated connection between the couplers that are stacked preferably in a vertical direction. The coupler comprises a pin that is fit into the open gap of another coupler in the concatenated connection of the couplers in order to constrain the retention member from deflection to thereby ensure proper positioning of the tool piece fit thereto and use safety for being suspended. As such, the drawbacks of the existing problems in manufacturing socket like tool pieces in connection with high manufacturing costs and not satisfying the desire for theft resistance in being suspended condition can be overcome.

The present invention aims to provide a coupler that comprises an upper portion forming a projecting stepwise insertion section and that forms therein a recessed complementary insertion slot so that two couplers are connectable to each other through simple operation of insertion. The coupler has a side face from which a retention member projects to receive a socket like tool piece to fit thereto. The retention member has one side wall that forms an open gap with respect to the coupler to provide resiliency for deflection for removal and fitting of the tool piece from and to the retention member. The coupler comprises a pin that can be inserted into the open gap of another coupler connected thereto in concatenate form, so that the couplers, after connected to each other in concatenate form, can be directly suspended for exhibition for sale and the tool pieces fit thereto are securely retained without potential risk of detaching and falling and are secured against theft. The retention members, after the pins being removed, can be deflected to allow for easy removal or re-fitting of the tool pieces. The whole structure provides the advantages and functions of security against theft and easy fitting and removal of tool piece in a suspended condition.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a suspension structure according to the present invention.

FIG. 2 is a prospective view of the suspension structure of the present invention.

FIG. 3 is a perspective view of the suspension structure of the present invention, demonstrating removal of a tool piece therefrom.

FIG. 4 is a cross-sectional view of the suspension structure according to the present invention with a tool piece retained thereon.

FIG. 5 is a cross-sectional view of the suspension structure according to the present invention, demonstrating removal of a tool piece therefrom.

FIG. 6 is an exploded view showing a conventional tool suspension device.

FIG. 7 is a perspective view of the conventional tool suspension device.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

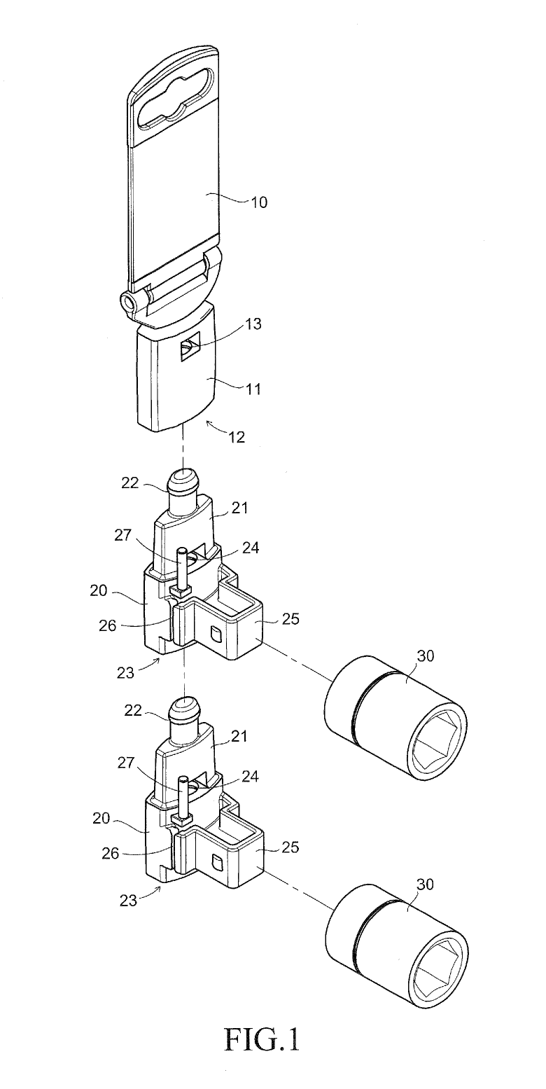

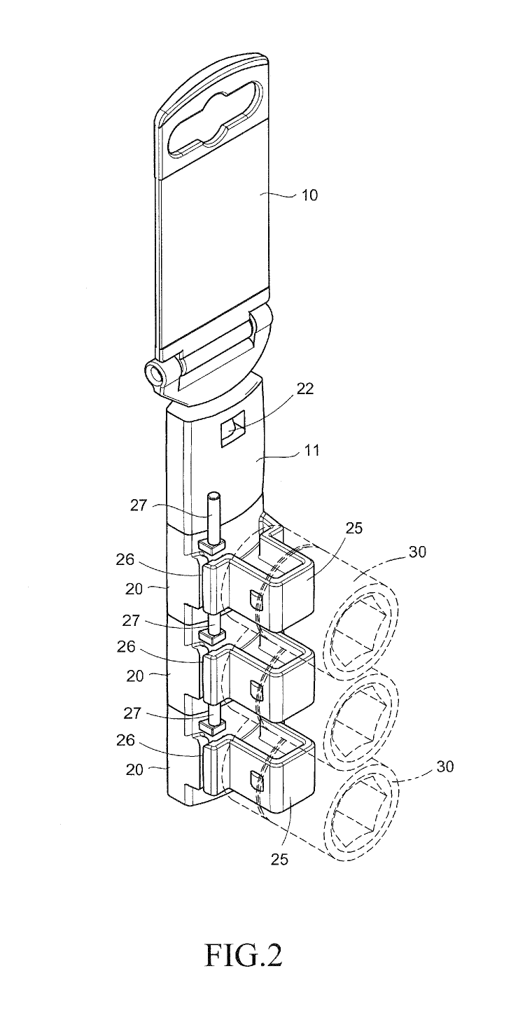

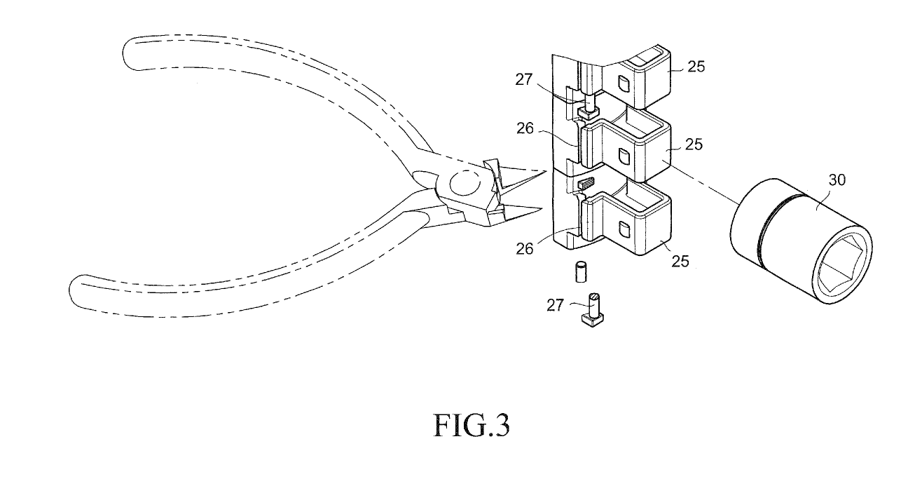

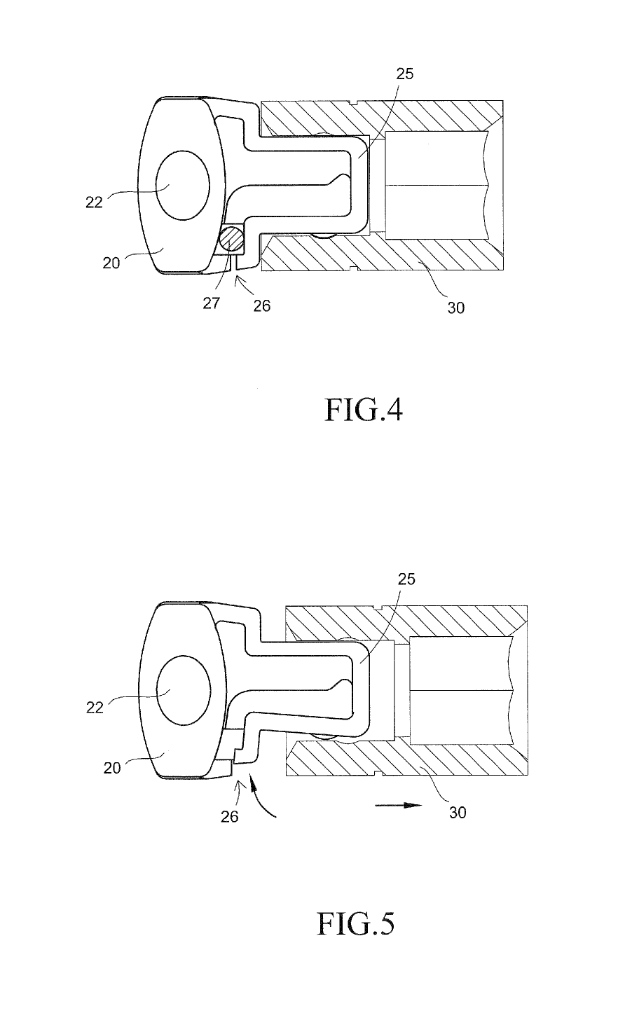

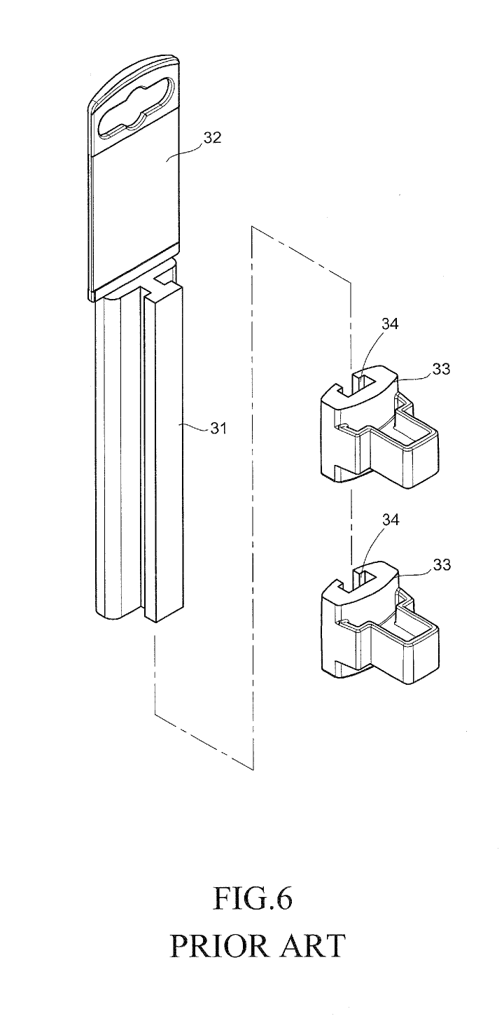

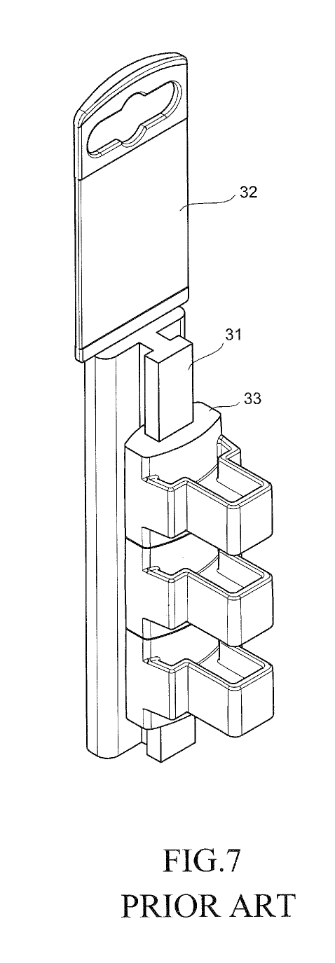

The present invention provides a concatenate safety tool suspension structure. As shown in FIGS. 1-5, the suspension structure according to the present invention comprises a suspension board 10 that is provided for suspension and is in the form of an elongate plate having a lower portion which forms a connector 11 extending a predetermined length and having a lower end in which a recessed insertion slot 12 is formed. The slot has a shape corresponding to an outer configuration of an insertion section 21 extending from an upper end of a suspension coupler 20 and has an inner end in which a bore 13 is formed. The connector 11 is rotatably jointed to the suspension board 10 to allow an upper section of the suspension board 10 to be foldable for reducing the amount of packaging material used. The suspension coupler 20 is set in a substantially L-shaped, wherein an upper end of the coupler 20 comprises an insertion section 21 extending therefrom for concatenated connection. The insertion section shows a peg like configuration of stepwise reduction having a length substantially the same as the coupler 20 itself. The insertion section 21 has an upper end forming a barb-like connection end 22. The coupler 20 forms therein a stepwise insertion slot 23 complementary to the insertion section 21 and also forms a through hole 24 in an upper end of the insertion slot to receive the barb connection end 22 (of a lower next coupler) to extend therethrough and to engage the upper end of the coupler 20 thereby realize concatenate connection. The coupler 20 comprises a retention member 25 extending sideways therefrom for receiving a socket like tool piece 30 to fit thereon. The retention member is made hollow and has two side walls of which one is mounted to the coupler while the other is spaced from the coupler 20 to define a gap 26 therebetween to thereby provide a deflectable and spaced arrangement. The coupler comprises a pin 27 that is located above the open gap 26 and extends a predetermined length in parallel to an axial direction of the coupler so that when two couplers 20 are fit to each other for concatenate connection, the pin 27 is partially fit into the gap 26 to limit resilient opening/closing of the gap 26 and thus imposing a constraint to the deflectability of the side wall of the retention member 25 to thereby realize security and theft resistance for the tool piece 30 fit to the retention member 35. The pin 27 can be circular in cross section or has a shape complementary to inside configuration of the gap 26 so that when the pin 27 is inserted into the gap 26, no undesired shift and spacing occurring therebetween to ensure the result of theft resistance. A manufacturer may make a package of two or three couplers that carry two or three different, but most commonly used or minimum sizes of tool piece 30 for exhibition and sale. Since the couplers 20 can be connected in concatenate form and the retention members 25 are prevented from deflection, the safety and security of the tool pieces 30 fit to the retention members 25 can be realized and there will be no concern for being stolen or falling. Based on their needs, consumers may purchase a desired number of tool pieces 30 having the desired specifications and may simply concatenate the couplers that carry the tool pieces together in an almost unlimited fashion. This allows for easy access and storage of the socket like tool pieces 30.

An alternative form of the coupler 20 is to provide connection strips extending across the open gap 26 at opposite ends of the gap for securing the retention member 25 against deflection so as to realize theft resistance for the tool piece 30 fit to the retention member 25. This is considered a modification that belongs to the scope of the present invention. A consumer, after purchasing a tool piece attached to a coupler, may use a pair of scissors or pliers to cut off the pin 27 or the connection strips, as shown in FIG. 35, to release the retention member 25 so that the retention member 25 can be deflected to a desired angle and such a deflection allows the tool piece 30 to be readily removed, as well as being re-fit to, the retention member. The suspension structure according to the present invention provides the advantages of exhibition and security of suspension.

With the simple fitting and connection arrangement provided by the present invention, the mode of use of the socket like tool piece 30 is greatly changed, and the manufacture of small quantity of diverse suspension devices with various specifications is made easy. For consumers, suspension, assembly, use, and classification of various and unique specifications can be realized according to practical applications. The whole structure or the quantity to be suspended can be arbitrarily combined as the user desires. Apparently, the present invention is a design of user friendliness that shows practical functionalities. Further, in the point view of manufacturing, the material cost can be minimized, for no rail bar is needed for extending through and retaining the couplers, whereby the weight is reduced and the manufacture is flexible, making it being economic valuable. It is important that the present invention allows a user to make arbitrary combination based on his or her needs. The unlimited expansion for suspension of tool pieces provides multiple advantages of easy molding and ready assembling.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A concatenate tool suspension structure comprising a plate like suspension board and a coupler to which a tool piece is attachable by fitting, an insertion section being formed to extend from an upper end of the coupler and having an upper end forming a barbed connection end, the coupler having a lower end forming a recessed insertion slot, which receives the insertion section of an additional coupler to fit therein, a through hole being formed in an upper end of the insertion slot in the coupler to receive the barbed connection end to extend therethrough and engage therewith, a retention member being mounted to one side face of the coupler and extending sideways therefrom to receive the tool piece to fit thereto, the retention member having a side wall that is spaced from the coupler to form an open gap therebetween to provide deflectability for removal of the tool piece that is fit to the retention member, the coupler being selectively fit to a connector formed under the suspension board to form a complete suspension structure, the coupler comprising a pin that is selectively fit into the open gap to ensure theft resistance in exhibition of the tool piece attached to the coupler.

2. The concatenate tool suspension structure according to claim 1, wherein the insertion section shows a peg like configuration of stepwise reduction.

3. The concatenate tool suspension structure according to claim 1, wherein the pin is arranged on the coupler at a location above the open gap.

4. The concatenate tool suspension structure according to claim 1, wherein the pin has a circular cross-section.

5. The concatenate tool suspension structure according to claim 1, wherein the pin has a shape complementary to inside configuration of the gap.

6. The concatenate tool suspension structure according to claim 1, wherein the open gap comprises two connection strips mounted to opposite ends thereof.

7. The concatenate tool suspension structure according to claim 1, wherein the connector is rotatably jointed to the suspension board.

8. The concatenate tool suspension structure according to claim 1, wherein the insertion slot of the connector is shaped to correspond to an outer configuration of the insertion section of the coupler.

9. The concatenate tool suspension structure according to claim 1, wherein the insertion slot of the coupler is shaped complementary to the configuration of the insertion section of the coupler.
